(19) United States
(12) Patent Application Publication
(10) Pub. No.: US 2026/0057756 A1
(43) Pub. Date: Feb. 26, 2026

(54) WORK MACHINE GUIDANCE DEVICE AND WORK MACHINE GUIDANCE METHOD

(71) Applicant: FUJI CORPORATION, Chiryu (JP)

(72) Inventor: Yoshiharu TANIZAWA, Toyota-shi (JP)

(73) Assignee: FUJI CORPORATION, Chiryu (JP)

(21) Appl. No.: 18/998,891

(22) PCT Filed: Sep. 12, 2022
(86) PCT No.: PCT/JP2022/034064

§ 371 Date: Jan. 27, 2025

(51) Int. Cl. G08B 21/18; G08B 5/22

(52) U.S. Cl. CPC G08B 21/18; G08B 5/22

(57) ABSTRACT

A work machine notification device includes a determination section and a notification section. The determination section determines whether a board work machine configured to perform a predetermined board work on a board is a compatible work machine that can be remotely operated by a worker. The notification section notifies the compatible work machine to the worker when the determination section determines that the board work machine is the compatible work machine.

### TECHNICAL FIELD

The present description discloses a technique relating to a work machine notification device and a work machine notification method.

### BACKGROUND ART

The component mounting system described in Patent Literature 1 includes an operation authority setting section and an error type determination section. The operation authority setting section sets, for a management device, a remote operation authority for enabling remote operation of a processing device by an input section of the management device. The error type determination section determines a type of an error that has occurred in the processing device. Further, the error type determination section determines whether an error occurring in the processing device is a remote-handling error which is a target error that can be handled by remote operation from the management device, and the operation authority setting section sets the remote operation authority for the management device when the error is the remote-handling error.

### CITATION LIST

### Patent Literature

Patent Literature 1: JP-A-2017-143167

### BRIEF SUMMARY

### Technical Problem

When a worker performs work using a board work machine, it may be unclear whether the board work machine can be remotely operated. Therefore, it is necessary for the worker to confirm the setting of the board work machine, and the working efficiency may be reduced.

In view of such circumstances, the present description discloses a work machine notification device and a work machine notification method in which a worker can easily confirm a board work machine that can be remotely operated.

### Solution to Problem

The present description discloses a work machine notification device including a determination section and a notification section. The determination section determines whether a board work machine configured to perform a predetermined board work on a board is a compatible work machine that can be remotely operated by a worker. The notification section notifies the compatible work machine to the worker when the determination section determines that the board work machine is the compatible work machine.

The present description also discloses a work machine notification method including a determination step and a notification step. In the determination step, it is determined whether a board work machine configured to perform a predetermined board work on a board is a compatible work machine that can be remotely operated by a worker. In the notification step, the compatible work machine is notified to the worker when it is determined in the determination step that the board work machine is the compatible work machine.

### Advantageous Effects

According to the work machine notification device described above, it is possible to notify the board work machine that can be remotely operated, to the worker. As a result, the worker can easily confirm the board work machine that can be remotely operated, and can suppress a decrease in working efficiency. The above description of the work machine notification device can be similarly applied to the work machine notification method.

### BRIEF DESCRIPTION OF DRAWINGS

FIG. 1 is a configuration diagram illustrating a configuration example of a production line.

FIG. 2 is a plan view illustrating a configuration example of a component mounter.

FIG. 3 is a block diagram illustrating an example of a control block of a work machine notification device.

FIG. 4 is a flowchart illustrating an example of a control procedure executed by the work machine notification device.

FIG. 5 is a diagram illustrating a notification example of a compatible work machine by the work machine notification device.

### DESCRIPTION OF EMBODIMENTS

### 1. Embodiment

### 1-1. Configuration Example of Production Line WL0

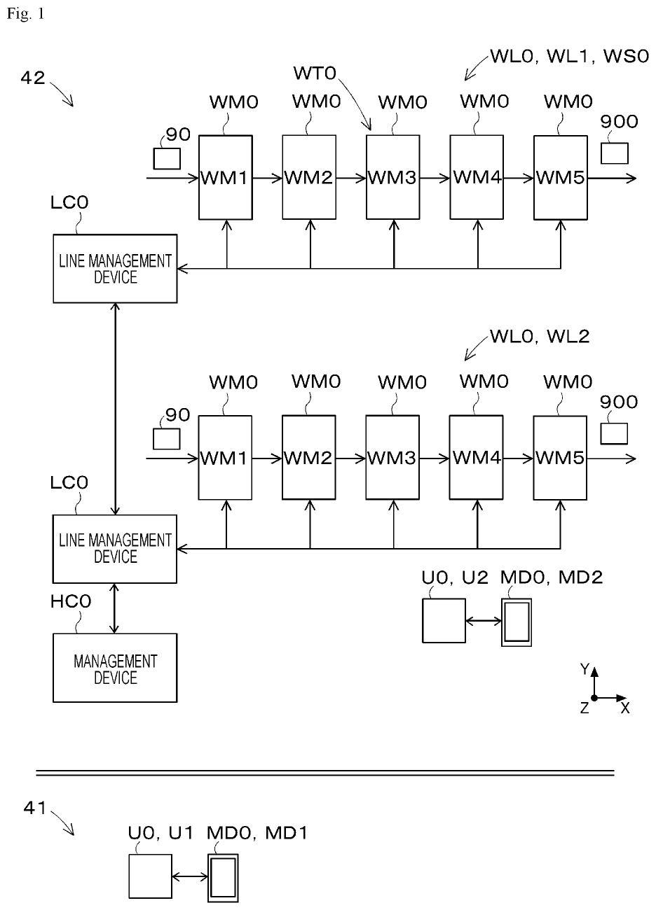

Work machine notification device 50 can be applied to at least one production line WL0 including remotely operated board work machine WM0. As illustrated in FIG. 1, a production facility of the embodiment includes two production lines WL0, that is, first production line WL1 and second production line WL2.

In each of two production lines WL0, board work machine WM0 performs a predetermined board work on board 90. The type and number of board work machines WM0 constituting production line WL0 are not limited. As illustrated in FIG. 1, production line WL0 of the embodiment includes multiple board work machines WM0, which are printer WM1, printing inspector WM2, component mounter WM3, reflow oven WM4, and visual inspector WM5, and board 90 is conveyed in the order described above by a board convey ance device.

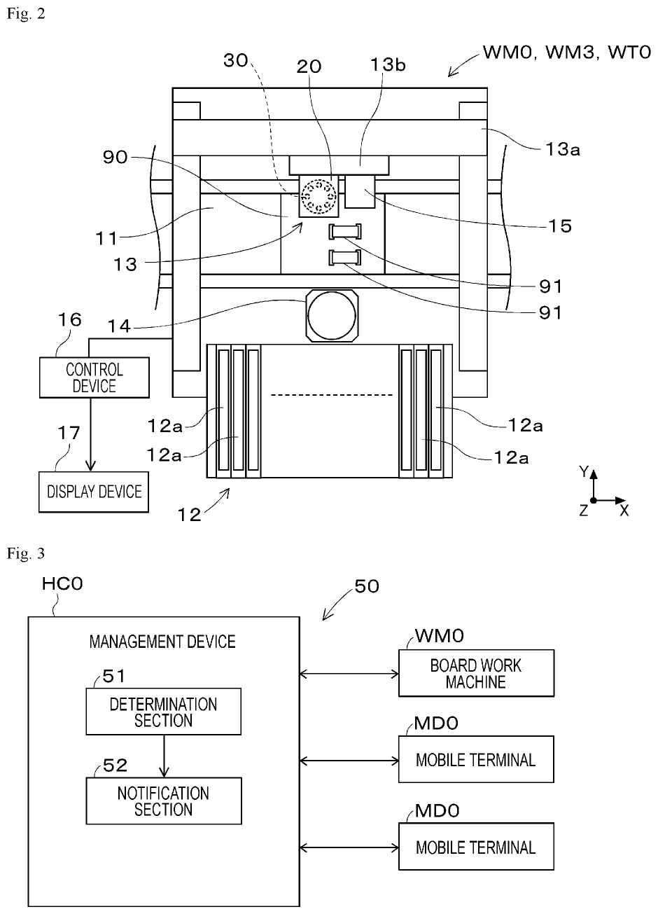

Printer WM1 prints a solder on mounting positions of multiple components 91 of board 90. Printing inspector WM2 inspects a print state of the solder which is printed by printer WM1. As illustrated in FIG. 2, component mounter WM3 mounts multiple components 91 on board 90 on which the solder is printed by printer WM1. One or multiple component mounters WM3 may be provided. In a case in which multiple component mounters WM3 are provided, multiple component mounters WM3 can be shared to mount multiple components 91.

Reflow oven WM4 heats board 90 on which multiple components 91 are mounted by component mounter WM3, causes the solder to melt, and performs soldering. Visual inspector WM5 inspects mounting states or the like of multiple components 91 which are mounted by component mounter WM3. In this way, production line WL0 can convey board 90 in order using multiple board work machines WM0 and execute a production process including an inspection process to thereby produce board product 900. Production line WL0 may include board work machines WM0 such as a function inspector, a buffer device, a board supply device, a board reversing device, a shield mounting device, an adhesive coating device, and an ultraviolet irradiation device as needed.

Multiple board work machines WM0, which constitute production line WL0, and line management device LC0 are connected so as to be communicable with each other by a communication section. Line management device LC0 and management device HC0 are also connected so as to be communicable with each other by the communication section. The communication section can communicably connect multiple board work machines WM0 and line management device LC0 or line management device LC0 and management device HC0 by wired or wireless communication, and a communication method can take various methods.

In the embodiment, a Local Area Network (LAN) is configured with multiple board work machines WM0, line management device LC0, and management device HC0. As a result, multiple board work machines WM0 can communicate with one another via the communication section. In addition, multiple board work machines WM0 can communicate with line management device LC0 via the communication section. In addition, line management device LC0 and management device HC0 can communicate with each other via the communication section.

Line management device LC0 controls multiple board work machines WM0, which constitute production line WL0, and monitors an operation status of production line WL0. Line management device LC0 stores various types of control data for controlling multiple board work machines WM0. Line management device LC0 transmits control data to each of multiple board work machines WM0. In addition, each of multiple board work machines WM0 transmits an operation status and a production status thereof to line management device LC0.

Management device HC0 manages at least one (two, in FIG. 1) line management device LC0. For example, the operation status and the production status of board work machine WM0 acquired by line management device LC0 are transmitted to management device HC0 as needed. A storage device is provided in management device HC0. Storage device can store various types of acquired data acquired by board work machine WM0. For example, various types of image data imaged by board work machine WM0 are included in the acquired data. The record (log data) of the operation status acquired by board work machine WM0 or the like is included in the acquired data. In addition, the storage device can store various types of production information related to the production of board product 900.

### 1-2. Configuration Example of Component Mounter WM3

Component mounter WM3 mounts multiple components 91 on board 90. As illustrated in FIG. 2, component mounter WM3 includes board conveyance device 11, component supply device 12, component transfer device 13, part camera 14, board camera 15, control device 16, and display device 17.

For example, board convey ance device 11 includes a belt conveyor and the like, and conveys board 90 in a convey ance direction (X-axis direction). Board 90 is a circuit board, on which an electronic circuit, an electrical circuit, a magnetic circuit, and the like are formed. Board conveyance device 11 loads board 90 into component mounter WM3, and positions board 90 at a predetermined position inside component mounter WM3. After a mounting process of multiple components 91 by component mounter WM3 ends, board conveyance device 11 carries board 90 out of component mounter WM3.

Component supply device 12 supplies multiple components 91 to be mounted on board 90. Component supply device 12 includes multiple feeders 12a, which are provided along the conveyance direction (X-axis direction) of board 90. Each of multiple feeders 12a is equipped with a reel. A carrier tape accommodating multiple components 91 is wound around the reel. Feeder 12a feeds the carrier tape pitch by pitch to supply components 91 such that component 91 can be picked up at a supply position located on a distal end side of feeder 12a. In addition, component supply device 12 can also supply a relatively large electronic component (for example, a lead component or the like) as compared with a chip component or the like in a state of being disposed on a tray.

Component transfer device 13 includes head driving device 13a and moving table 13b. Head driving device 13a is configured to move moving table 13b in the X-axis direction and a Y-axis direction (a direction orthogonal to the X-axis direction on a horizontal plane) by a linear motion mechanism. Mounting head 20 is detachably (replaceably) provided on moving table 13b by a clamp member. Mounting head 20 picks up and holds component 91 supplied by component supply device 12 by using at least one holding member 30, and mounts component 91 on board 90 positioned by board conveyance device 11. For example, a suction nozzle, a chuck, or the like can be used for holding member 30.

As part camera 14 and board camera 15, a known imaging device can be used. Part camera 14 is fixed to a base of component mounter WM3 such that an optical axis thereof is oriented upwards in a vertical direction (a Z-axis direction orthogonal to the X-axis direction and the Y-axis direction). Part camera 14 can image component 91 held by holding member 30 from below. Board camera 15 is provided on moving table 13b of component transfer device 13 such that an optical axis thereof is oriented downwards in the vertical direction (the Z-axis direction). Board camera 15 can image board 90 from above. Part camera 14 and board camera 15 perform imaging based on a control signal transmitted from control device 16. Image data of the image captured by part camera 14 and board camera 15 is transmitted to control device 16.

Control device 16 includes a known arithmetic device and a storage device, and constitutes a control circuit. The information, image data, and the like output from various sensors provided in component mounter WM3 are input to control device 16. Control device 16 transmits the control signals to each device based on a control program, a predetermined mounting condition, which is set in advance, and the like.

For example, control device 16 causes board camera 15 to image board 90 which is positioned by board conveyance device 11. Control device 16 performs image processing on the image captured by board camera 15 to recognize a positioning state of board 90. Moreover, control device 16 causes holding member 30 to pick up and hold component 91 supplied by component supply device 12, and causes part camera 14 to image component 91 held by holding member 30. Control device 16 performs the image processing on the image captured by part camera 14 to recognize a holding posture of component 91.

Control device 16 moves holding member 30 toward above a scheduled mounting position, which is set in advance by the control program or the like. Further, based on the positioning state of board 90, the holding posture of component 91, and the like, control device 16 corrects the scheduled mounting position to set the mounting position on which component 91 is actually mounted. The scheduled mounting position and the mounting position include a rotation angle in addition to the position (X-axis coordinate and Y-axis coordinate).

Control device 16 corrects a target position (X-axis coordinate and Y-axis coordinate) of holding member 30 and the rotation angle in accordance with the mounting position. Control device 16 lowers holding member 30 at the corrected rotation angle at the corrected target position to mount component 91 on board 90. Control device 16 repeats the pick-and-place cycle to execute the mounting process of mounting multiple components 91 on board 90.

As display device 17, for example, a known display device such as a liquid crystal display can be used, and various information can be displayed to worker U0. In addition, in the embodiment, display device 17 is made up of a touch panel and also functions as an input device for receiving various operations by worker U0.

### 1-3. Configuration Example of Work Machine Notification Device 50

As illustrated in FIG. 1, the production facility of the embodiment includes remote room 41 and production room 42. Remote room 41 is partitioned from production room 42 including at least one (two in FIG. 1) production line WL0, and worker U0 can remotely operate board work machine WM0 of production line WL0 from remote room 41.

When worker U0 performs work by using board work machine WM0, it may be unclear whether board work machine WM0 can be remotely operated. Therefore, it is necessary for worker U0 to confirm the setting of board work machine WM0, and the working efficiency may be reduced. The production facility of the embodiment is provided with work machine notification device 50. Work machine notification device 50 notifies compatible work machine WT0 which is board work machine WM0 that can be remotely operated, to worker U0.

Work machine notification device 50 includes determination section 51 and notification section 52 as a control block. The work machine notification device 50 can be provided in various control devices. For example, the work machine notification device 50 can be provided in line management device LC0, management device HC0, or the like. Work machine notification device 50 may be formed on a cloud. As illustrated in FIG. 3, in work machine notification device 50 of the embodiment, determination section 51 and notification section 52 are provided in management device HC0.

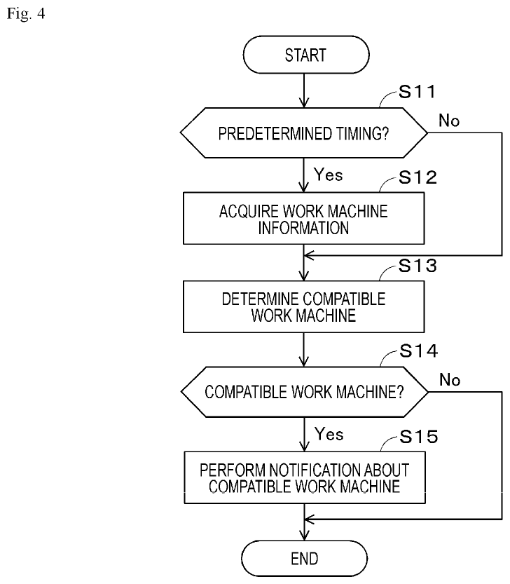

Work machine notification device 50 of the embodiment executes control according to the flowchart illustrated in FIG. 4. Determination section 51 performs determination and processing illustrated in step S11 to step S13. Notification section 52 performs determination and processing illustrated in step S14 and step S15. The items described in the present description can be appropriately combined and can be omitted and selected.

### 1-3-1. Determination Section 51

Determination section 51 determines whether board work machine WM0 that performs a predetermined board work on board 90 is a compatible work machine WT0 that can be remotely operated by worker U0. Determination section 51 only needs to be capable of determining whether board work machine WM0 is compatible work machine WT0 and may have various forms.

For example, there is a case where the remote operation by worker U0 cannot be possible for board work machine WM0 whose manufacturing date is earlier than a predetermined date. Further, even in the case of board work machine WM0 that can be remotely operated by worker U0, the remote operation function may be disabled. Board work machine WM0 recognizes its own function, and recognizes whether the remote operation of board work machine WM0 by worker U0 is possible (including whether the remote operation function is enabled). Then, determination section 51 communicates with board work machine WM0 to acquire work machine information indicating whether board work machine WM0 is compatible work machine WT0, and can determine whether board work machine WM0 is compatible work machine WT0 based on the acquired work machine information (step S12 and step S13 shown in FIG. 4).

Determination section 51 can acquire the work machine information at any timing. However, for example, when an abnormality occurs in board work machine WM0 and worker U0 performs the handling work by remote operation, it may be difficult to acquire the work machine information. In addition, even in a case where the work machine information can be acquired, a certain time is required to acquire the work machine information, and there is a possibility that the handling work is delayed. Here, determination section 51 may acquire the work machine information at at least one of a timing at which work machine notification device 50 is activated and a timing at which board work machine WM0 is activated (step S11 and step S12). The activation of work machine notification device 50 and board work machine WM0 includes reactivation.

As a result, determination section 51 can determine whether board work machine WM0 is compatible work machine WT0 before the remote operation of board work machine WM0 is required. In addition, determination section 51 can handle the setting change (the change of enabling or disabling the remote operation) of the remote operation that occurs after the activation of work machine notification device 50 by acquiring the work machine information at the timing of the activation, including the reactivation, of board work machine WM0.

Worker U0 can perform various remote operations on board work machine WM0. For example, the remote operation of board work machine WM0 includes at least one of a handling work for handling an abnormality that has occurred in board work machine WM0, a maintenance work of board work machine WM0, and a preparation work for board work machine WM0.

For example, when a temporary abnormality occurs in board work machine WM0, worker U0 may cancel the abnormality and restart the production. In a case where a result of image processing of an image obtained by imaging component 91 held by holding member 30 by part camera 14 is abnormal, worker U0 may edit shape data of component 91. In addition, when a printing defect is determined by printing inspector WM2, worker U0 may adjust control parameters of printer WM1 such as a printing pressure and a printing speed of solder. This work is included in the handling work for handling the abnormality that has occurred in board work machine WM0.

For example, in order to perform maintenance on holding member 30, worker U0 may instruct replacement of holding member 30 using mounting head 20. Further, in order to perform maintenance on a mask of printer WM1, worker U0 may instruct printer WM1 to automatically clean the mask. This work is included in the maintenance work of board work machine WM0. In addition, in order to change the setup of board work machine WM0, worker U0 may instruct an automated guided vehicle to convey members such as component 91 and the solder. This work is included in the preparation work for board work machine WM0.

The handling work, the maintenance work, and the preparation work may include various works, and are not limited to the works described above. In addition, the compatible work machine WT0 does not vary depending on the type of the work described above, but only needs to be board work machine WM0 that can be remotely operated by worker U0.

### 1-3-2. Notification Section 52

When determination section 51 determines that board work machine WM0 is compatible work machine WT0, notification section 52 notifies compatible work machine WT0 to worker U0 (step S14 and step S15 illustrated in FIG. 4). Notification section 52 only needs to be capable of notifying compatible work machine WT0 to worker U0 and may have various forms. Notification section 52 can always perform a notification about compatible work machine WT0. For example, when there is a request such as a display request, notification section 52 can perform a notification about compatible work machine WT0.

For example, notification section 52 can perform a notification about compatible work machine WT0 to at least one of mobile terminal MD0 and compatible work machine WT0 carried by worker U0. As illustrated in FIG. 1, worker U0 of the embodiment carries mobile terminal MD0 capable of wirelessly communicating with a device of a production facility. Examples of mobile terminal MD0 include a tablet terminal, an arm clock terminal, and the like. In this case, notification section 52 may perform a notification about compatible work machine WT0 on at least mobile terminal MD0. Accordingly, notification section 52 can directly notify the compatible work machine WT0 to worker U0.

In addition, there is a case where the remote operation of board work machine WM0 can be executed by specific worker U1, who is specified worker U0. For example, worker U0 having a predetermined technical level, worker U0 who has completed a predetermined work training, and the like are included in the specific worker U1. As described above, when the remote operation of board work machine WM0 can be executed by specific worker U1, it is not necessary to notify compatible work machine WT0 to general worker U2 who is worker U0 other than the specific worker U1.

Here, in a case where the remote operation of board work machine WM0 can be executed by specific worker U1, notification section 52 may perform a notification about compatible work machine WT0 on mobile terminal MD0 carried by specific worker U1. Accordingly, notification section 52 can directly notify compatible work machine WT0 to specific worker Ul who needs to be notified. In FIG. 1, for convenience of illustration, mobile terminal MD0 carried by specific worker U1 is illustrated by specific mobile terminal MD1, and mobile terminal MD0 carried by general worker U2 is illustrated by general mobile terminal MD2.

In addition, the remote operation of board work machine WM0 may be executed in at least one specific production line WS0 among multiple production lines WL0 in which board work machine WM0 is provided. For example, the production facility illustrated in FIG. 1 includes two production lines WL0, which are first production line WL1 and second production line WL2. For example, it is assumed that component mounter WM3 of first production line WL1 is compatible work machine WT0 and first production line WL1 is specific production line WS0. In this case, it is not necessary to notify compatible work machine WT0 to worker U0 in charge of second production line WL2.

Here, in a case where the remote operation of board work machine WM0 is executable in specific production line WS0, notification section 52 may perform a notification about compatible work machine WT0 on mobile terminal MD0 carried by worker U0 in charge of specific production line WS0. Accordingly, notification section 52 can directly notify compatible work machine WT0 to worker U0 who is in charge of specific production line WS0 and needs to be notified.

Notification section 52 can perform a notification about compatible work machine WT0 such that worker U0 can recognize the compatible work machine through at least one of a visual sense, an auditory sense, and a tactile sense of worker U0. For example, notification section 52 can perform a notification about compatible work machine WT0 on at least one display screen DP0 among the display devices of mobile terminal MD0 and board work machine WM0 (for example, display device 17 of component mounter WM3) carried by worker U0. Notification section 52 can also provide audio notification to compatible work machine WT0. Furthermore, notification section 52 can also cause mobile terminal MD0 carried by worker U0 to vibrate to perform a notification about a change in compatible work machine WT0 accompanying a change in setting of the remote operation (a change in enabling or disabling the remote operation).

For example, notification section 52 can perform a notification about compatible work machine WT0 with character information (for example, identification information (module number) capable of identifying compatible work machine WT0, identification information (line number) capable of identifying production line WL0, or the like) on display screen DP0. In addition, notification section 52 can also display compatible work machine WT0 with predetermined icon IN1 on display screen DP0 that simulates and displays production line WL0 on which board work machine WM0 is provided. For example, as illustrated in FIG. 5, an image simulating production line WL0 (for example, first production line WL1) illustrated in FIG. 1 is displayed on a part (for example, a lower part) of display screen DP0 of mobile terminal MD0 carried by worker U0. In production line WL0, at least one board work machine WM0 (in FIG. 5, four board work machines WM0 of printing inspector WM2, component mounter WM3, reflow oven WM4, and visual inspector WM5) is arranged.

On an upper part of at least one board work machine WM0 among four board work machines WM0 (in FIG. 5, one component mounter WM3 which is compatible work machine WT0), for example, icon IN1 simulating a conical object in which a red main body portion used in a construction site is marked with a white line is attached. As a result, worker U0 can easily confirm compatible work machine WT0 from among multiple (four) board work machines WM0. In addition, icon IN2 in which a white X mark is applied to a red circular plate is attached to at least one of other board work machines WM0 among four board work machines WM0 (in FIG. 5, one printing inspector WM2).

In addition, icon IN3 in which a black exclamation mark is applied to a yellow triangular plate is attached to at least one of other board work machines WM0 among four board work machines WM0 (in FIG. 5, one reflow oven WM4). Further, icon IN4 in which a white exclamation mark is applied to a black circular plate is attached to at least one of other board work machines WM0 among four board work machines WM0 (in FIG. 5, one visual inspector WM5). Icon IN2 to icon IN4 indicate the production state of board product 900 in board work machine WM0 (for example, board work machine WM0 serving as a bottle neck that reduces productivity of production line WL0).

Notification section 52 can also display task information indicating work that worker U0 is required to execute on display screen DP0 that simulates and displays production line WL0 in which the board work machine WM0 is provided. Then, notification section 52 can also display specific work TK1 performed by worker U0 remotely operating compatible work machine WT0 in the task information so as to be distinguishable from other works. For example, as illustrated in FIG. 5, task information is displayed on a part (for example, an upper part) of display screen DP0 of mobile terminal MD0 carried by worker U0.

For example, the task information includes information related to production line WL0 (identification information (line number) capable of identifying production line WL0, and the like). In FIG. 5, for convenience of illustration, first production line WL1 and second production line WL2 are illustrated. In addition, the task information includes information related to board work machine WM0 (identification information (module number) capable of identifying compatible work machine WT0 and the like). In FIG. 5, for convenience of illustration, printer WM1, printing inspector WM2, component mounter WM3, reflow oven WM4, and visual inspector WM5 are illustrated.

Further, the task information includes information related to an execution time of the task (a start time, a completion time, and the like of the task). In FIG. 5, for convenience of illustration, start time T1 to start time T7 are illustrated. For example, for a task for which the start time has passed, the start time is highlighted to call attention to worker U0. In addition, the task information includes information related to the work content (the abnormality content (error code, error message) and the like that has occurred in board work machine WM0). In FIG. 5, for convenience of illustration, abnormality content E1 to abnormality content E7 are illustrated. Further, above-described icon IN1 to icon IN4 are attached to the task information.

Notification section 52 only needs to be capable of displaying specific work TK1 so as to be distinguishable from other works and may have various forms. For example, in the task information illustrated in FIG. 5, specific work TK1 is displayed larger than other works. Accordingly, worker U0 can easily recognize specific work TK1 from among multiple tasks. Notification section 52 can also make a display color (at least one of a character color and a background color) of specific work TK1 different from that of the other works. Furthermore, notification section 52 can also blink specific work TK1.

Specific work TK1 includes various works that can be remotely operated by worker U0, and is not limited thereto. For example, specific work TK1 includes at least one of a handling work for handling an abnormality that has occurred in board work machine WM0, a maintenance work of board work machine WM0, and a preparation work for board work machine WM0. Specific work TK1 of the embodiment is at least one of the handling work for handling an abnormality that has occurred in board work machine WM0, the maintenance work of board work machine WM0, and the preparation work for board work machine WM0.

When the number of tasks in the task information exceeds a predetermined number, notification section 52 can make a region in which the image simulating production line WL0 is displayed smaller than that in FIG. 5 (the number of tasks is within the predetermined number), and the region in which the task information is displayed larger than that in FIG. 5. In addition, notification section 52 may display a display screen similar to display screen DP0 illustrated in FIG. 5 on the display device (for example, display device 17 of component mounter WM3) of board work machine WM0.

### 2. Work Machine Notification Method

The fact that work machine notification device 50 has already been described can be similarly applied to a work machine notification method. Specifically, the work machine notification method includes a determination step and a notification step. The determination step corresponds to control performed by determination section 51. The notification step corresponds to control performed by notification section 52.

### 3. Example of Effects of Embodiment

According to the work machine notification device 50, it is possible to notify board work machine WM0 that can be remotely operated, to worker U0. As a result, worker U0 can easily confirm the board work machine WM0 that can be remotely operated, and can suppress a decrease in working efficiency. The above description of the work machine notification device 50 can be similarly applied to the work machine notification method.

### REFERENCE SIGNS LIST

50: work machine notification device, 51: determination section, 52: notification section, 90: board,
U0: worker, U1: specific worker, MD0: mobile terminal,
DP0: display screen, IN1: icon, TK1: specific work,
WM0: Board work machine, WT0: compatible work machine, WL0: production line,
WS0: specific production line.

1. A work machine notification device comprising:
a determination section configured to determine whether a board work machine configured to perform a predetermined board work on a board is a compatible work machine that can be remotely operated by a worker; and
a notification section configured to notify the compatible work machine to the worker when the determination section determines that the board work machine is the compatible work machine.

2. The work machine notification device according to claim 1, wherein the determination section communicates with the board work machine to acquire work machine information indicating whether the board work machine is the compatible work machine, and determines whether the board work machine is the compatible work machine based on the acquired work machine information.

3. The work machine notification device according to claim 2, wherein the determination section acquires the work machine information at at least one of a timing at which the work machine notification device is activated and a timing at which the board work machine is activated.

4. The work machine notification device according to claim 1, wherein the notification section performs a notification about the compatible work machine in at least one of a mobile terminal and the compatible work machine carried by the worker.

5. The work machine notification device according to claim 4,
wherein the remote operation of the board work machine is executable by a specific worker, who is the worker specified, and
the notification section performs the notification about the compatible work machine on the mobile terminal carried by the specific worker.

6. The work machine notification device according to claim 4,
wherein the remote operation of the board work machine is executable in at least one specific production line among multiple production lines in which the board work machine is provided, and
the notification section performs a notification about the compatible work machine on the mobile terminal carried by the worker in charge of the specific production line.

7. The work machine notification device according to claim 1, wherein the notification section performs the notification about the compatible work machine such that the worker can recognize the compatible work machine through at least one of a visual sense, an auditory sense, and a tactile sense of the worker.

8. The work machine notification device according to claim 7, wherein the notification section displays the compatible work machine with a predetermined icon on a display screen that simulates and displays a production line in which the board work machine is provided.

9. The work machine notification device according to claim 7, wherein the notification section displays task information indicating work that the worker is required to execute on a display screen that simulates and displays a production line in which the board work machine is provided, and displays, within the task information, a specific work performed by the worker through remote operation of the compatible work machine, so as to be distinguishable from other work.

10. The work machine notification device according to claim 9, wherein the specific work is at least one of a handling work for handling an abnormality that has occurred in the board work machine, a maintenance work of the board work machine, and a preparation work for the board work machine.

11. A work machine notification method comprising:
a determination step of determining whether a board work machine configured to perform a predetermined board work on a board is a compatible work machine that can be remotely operated by a worker; and
a notification step of notifying the compatible work machine to the worker when the board work machine is determined to be the compatible work machine in the determination step.
